(19) United States
(12) Patent Application Publication
(10) Pub. No.: US 2026/0154304 A1
(43) Pub. Date: Jun. 4, 2026

(54) SYSTEM AND METHOD FOR DEEP UNDERSTANDING LONG-TAIL QUERIES AND APPLICATIONS THEREOF

(71) Applicant: YAHOO ASSETS LLC, New York, NY (US)

(72) Inventors: Seung Byum Seo, Champaign, IL (US); Chun Ming Sze, Fremont, CA (US); Xinhua Tan, Cupertino, CA (US); Arah Cho, Prosper, TX (US); Liuqing Li, San Jose, CA (US); Rao Shen, Sunnyvale, CA (US)

(21) Appl. No.: 18/965,557

(22) Filed: Dec. 2, 2024

(51) Int. Cl. G06F 16/334; G06F 16/383

(52) U.S. Cl. CPC G06F 16/334; G06F 16/383

(57) ABSTRACT

The present teaching relates to query related application based on deep understanding of intent/topic of the queries. When the query related application receives a query, the intent and topic associated with the query are estimated based on a semantic cache with triplets, each having a past query and intent/topic associated with the past query. The estimated intent/topic associated with the query facilitate the query related application to execute a task based on the query in accordance with the intent/topic thereof.

### BACKGROUND

### 1. Technical Field

The present teaching generally relates to information processing. More specifically, the present teaching relates to information understanding.

### 2. Technical Background

With the development of the Internet and the ubiquitous network connections, daily activities are often conducted online. Millions of user access, via network connections, digital content to keep informed of what is going on in the world. Such online digital content may be obtained via, e.g., a search engine, which may identify online content based on queries provided by users. Searching online content has become an essential part of daily lives of most and online content includes news, articles, music pieces, video content, communications, sales, as well as discussions directed to different topics. Nowadays, there are different ways to query for content. For example, some may query content using keywords. Some may query content using a sentence such as a question. There are also search engines that allow a user to provide an entire document as the query to retrieve content directed to topics/semantics as what is detected from the given document.

To obtain content via search according to a query, intent of the user who issues the query is often important in order to identify content that is relevant to the query according to the intent. Such an intent may be estimated based on the textual information of the query and/or sometimes other related information. In some situations, a downstream application that uses content searched via a query may also operate based on the intent of the query. As such, accurately understanding a query and reliably estimating the underlying intent are important. There is a need for an approach capable of better understanding a query but also more accurately estimating the intent associated with the query in order to uncover content relevant to the query according to the intent so as to enable enhanced application performance based on the searched content.

### SUMMARY

The teachings disclosed herein relate to methods, systems, and programming for information management. More particularly, the present teaching relates to methods, systems, and programming related to content summarization.

In one example, a method, implemented on a machine having at least one processor, storage, and a communication platform capable of connecting to a network for query related application based on deep understanding of intent/topic of the queries. When the query related application receives a query, the intent and topic associated with the query are estimated based on a semantic cache with triplets, each having a past query and intent/topic associated with the past query. The estimated intent/topic associated with the query facilitate the query related application to execute a task based on the query in accordance with the intent/topic thereof.

In a different example, a system is disclosed for displaying ads that includes a semantic cache generator and an intent/topic estimator. The semantic cache generator is configured for creating a semantic cache with a plurality of triplets, each of which includes a past query, an intent related to the past query, and a topic associated with the query. The intent/topic estimator is configured for receiving a query from a query-based application that is to perform a query-based tasks in response to the query, estimating an intent and a topic associated with the query based on the semantic cache, and providing the estimated intent and the estimated topic to the query-based application to facilitate execution of the query-based task in accordance with both the query and the estimated intent and the topic of the query associated therewith.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for query related application based on deep understanding of intent/topic of the queries. When the information is read by the machine, it causes the machine to perform multiple steps. When the query related application receives a query, the intent and topic associated with the query are estimated based on a semantic cache with triplets, each having a past query and intent/topic associated with the past query. The estimated intent/topic associated with the query facilitate the query related application to execute a task based on the query in accordance with the intent/topic thereof.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A shows an exemplary networked setting in which a query-based application operates based on a backend artificial intelligence (AI) based query intent estimator, in accordance with an embodiment of the present teaching;

FIG. 1B illustrates exemplary types of query-based applications;

FIG. 2A depicts exemplary high level system diagrams of a query-based application and an AI-based query intent estimator with corresponding interactions, in accordance with an embodiment of the present teaching;

FIG. 2B is a flowchart of an exemplary process of an AI-based query intent estimator for continually updating a semantic cache based on operational data collected from different sources, in accordance with an embodiment of the present teaching;

FIG. 2C is a flowchart of an exemplary process of a query-based application that performs a task in response to a query based on intent/topic of the query estimated utilizing a semantic cache, in accordance with an embodiment of the present teaching;

FIG. 3 depicts an alternative networked setting in which a query-based application operates to perform a task based on a query and intent/topic thereof estimated by an AI-based query intent estimator as a service across network, in accordance with an embodiment of the present teaching;

FIG. 4A depicts an exemplary high level system diagram of a semantic cache generator, in accordance with an embodiment of the present teaching;

FIG. 4B is a flowchart of an exemplary process of a semantic cache generator, in accordance with an embodiment of the present teaching;

FIG. 5A depicts an exemplary high level system diagram of an intent/topic estimator, in accordance with an embodiment of the present teaching;

FIG. 5B is a flowchart of an exemplary process of an intent/topic estimator, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses a scheme in which an AI-based intent estimation mechanism for establishing a semantic cache that enables efficient on-the-fly estimation of an intent/topic associated with a long-tail query to be utilized in a query-based application. A long-tail query may be defined to be a query with a certain number of words. For instance, a long-tail query may include more than 3 words. Most queries especially a question-like query are long-tail queries. The present teaching may be directed to long-tail queries as the focus thereof is on intent/topic estimation, which is based on a query with an adequate amount of text in order to carry out the estimation. The semantic cache created by the AI-based intent estimation mechanism may include triplets, each of which represents a query with its estimated intent and topic and is generated via machine learning based on data from different sources. The semantic cache is dynamically updated to be adaptive. In operation, when the query-based application receives a query, it may invoke the AI-based intent estimation mechanism to estimate, via the semantic cache, the intent/topic associated with the query to facilitate the operation thereof. In some embodiments, the AI-based intent estimation may be provided as the backend support for the query-based application. In some embodiments, the AI-based intent estimation may be a standalone mechanism provided as a service so that the semantic cache it continually maintains may be leveraged as a service to different query-based applications via network connections.

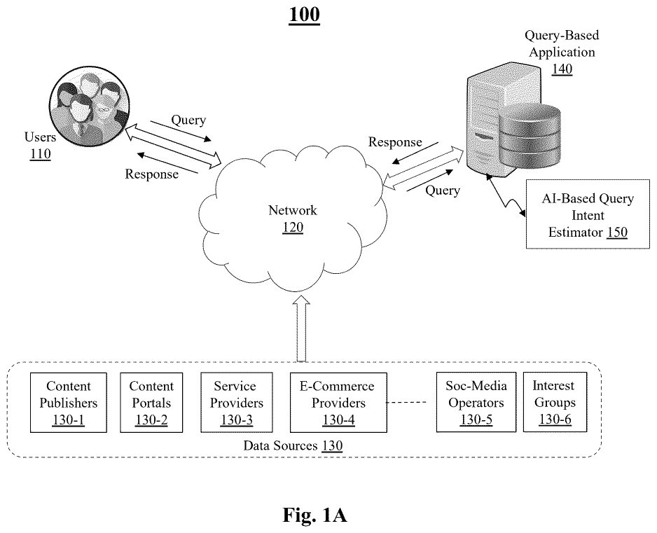

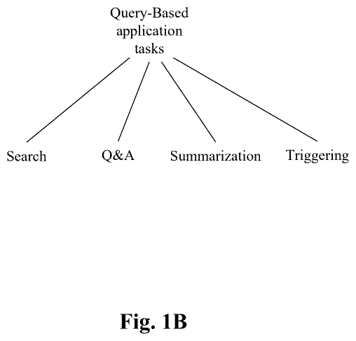

FIG. 1A shows an exemplary networked setting 100 in which a query-based application 120 operates based on a backend artificial intelligence (AI) based query intent estimator 150, in accordance with an embodiment of the present teaching. In this networked setting 100, when the query-base application 120 receives a query from a user 110 via network 120, it may invoke the AI-based query intent estimator 150 for estimating intent/topic of the query. Based on the estimated intent/topic associated with the query, the query-based application 120 may then generate a response and send to the user 110 as a response to the query. FIG. 1B illustrates exemplary types of query-based application tasks that the query-based application 120 may carry out to produce a response to a query in accordance with intent/topic estimated from the query. As shown, such query-based application tasks include search content based on a query, questions and answers (Q&A), content summary generation, or triggering a further operation in response to the query based on the intent of the query.

In some embodiments, the semantic cache may be created by the AI-based query intent estimator 150 via machine learning based on training data collected from different sources that may possess data that reveal relationships among queries, intents, and topics, so that such data may be used for machine learning to estimate intent/topic based on a query. In some embodiments, the data collected from different sources may correspond to information related to searches. For example, users may conduct searches using long-tail queries. When users received search results (each of which may correspond to a list of URLs representing corresponding online documents), certain URLs may be selected and the linked online documents may be reviewed by users with, e.g., some certain levels of engagement. Such data may reveal the relationships among queries, intents, and topics and may be used for training, via machine learning, how to predict an intent or a topic associated with a long-tail query.

In some situations, such data may be gathered from data sources 130 that may have search related data as well as activities users had directed to search results involved in such searches. In some embodiments, the data sources 130 may include content publishers 130-1, content portals 130-2, service providers 130-3, e-commerce providers 130-4, . . . , social media operators 130-5, and online interest groups 130-6. Data from these different sources may be processed to extract different types of information such as queries, titles of the searched online documents, selections of searched documents under different queries, and optionally indication of the levels of engagement that users had with respect to different online content. Information extracted from data collected from different data sources 130 may then be utilized as training data by the AI-based query intent estimator 150 to train a model for predicting intent/topic from a long-tail query based on learned relationships between queries and intents/topics evidenced via user activities directed to online documents searched based on such queries. The training data may also be used to establish the semantic cache for efficient on-the-fly estimation of intent/topic based on an input query.

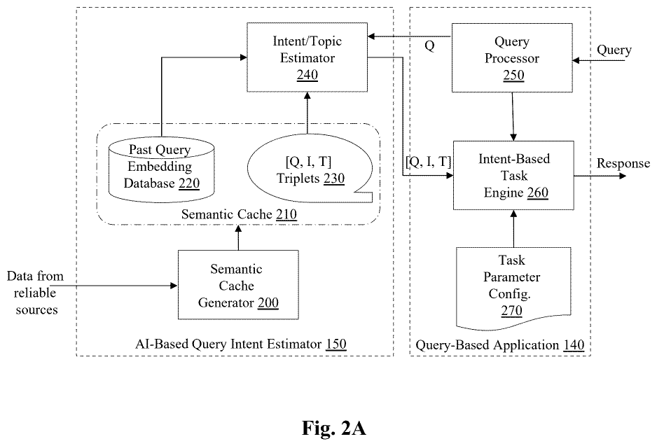

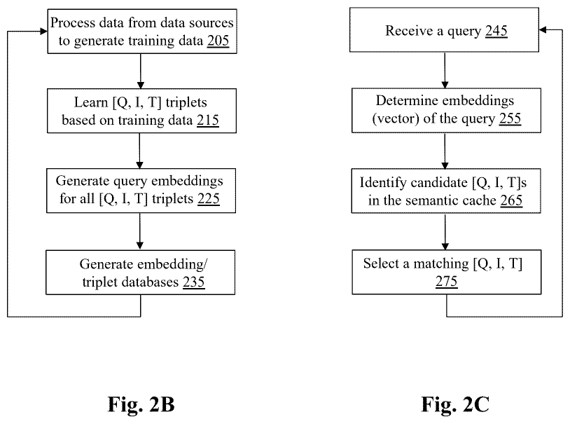

FIG. 2A depicts exemplary high level system diagrams of the query-based application 140 and the AI-based query intent estimator 150 with corresponding interactions, in accordance with an embodiment of the present teaching. As shown in FIG. 2A, the query-based application 140 receives a query and outputs a response directed to the query. To do so, the query Q is provided to the AI-based query intent estimator 150 so that the intent/topic associated with the query may be estimated. The estimated result from the AI-based query intent estimator 150 is a triplet [Q, I, T], where I in the triplet represents the estimated intent of the query Q and T in the triplet represents the estimated topic(s) associated with the query Q.

The exemplary internal construct of the query-based application 140 as shown in FIG. 2A comprises a query processor 250 and an intent-based task engine 260. The query processor 250 may be provided for processing a received from a user query by carrying out, e.g., textual information processing, to generate a properly formatted query Q to be provided to the AI-based query intent estimator 150. The intent-based task engine 260 may be provided to receive the triplet from the AI-based query intent estimator 150 and perform some pre-determined tasks according to the query and its associated intent I and topic(s) T in accordance with, e.g., some task related parameters as configured in 270. Execution of such preconfigured tasks may then produce an output response to be sent to the user.

On the other hand, the AI-based query intent estimator 150 comprises a semantic cache generator 200 and an intent/topic estimator 240. The semantic cache generator 200 may be provided for creating/maintaining a semantic cache 210 based on continually received training data from data sources 130. The semantic cache 210 may include a past query embedding database 220 and a storage for triplets [Q, I, T] s 230 learned from the training data from data sources 130. It is noted that the semantic cache 210 is dynamically and continuously updated to adapt to the training data from data sources 130. With the continually updated semantic cache 210, the intent/topic estimator 240 is provided for estimating, on-the-fly based on a query Q received from the query-based application 140, the intent and topic associated with the query based on the content stored in the semantic cache 210.

FIG. 2B is a flowchart of an exemplary process of the semantic cache generator 200 for creating the semantic cache 210 based on training data from data sources, in accordance with an embodiment of the present teaching. Upon receiving data from data sources, training data is created at 205 to enable machine learning. Based on the training data, triplets [Q, I, T] s are obtained via machine learning at 215. To facilitate on-the-fly estimation of intent/topic of a query received in operation, embeddings for each query in each learned triplet [Q, I. T] are generated at 225. Based on the learned triplets [Q, I, T] s and embeddings, the semantic cache 210 is generated at 235. FIG. 2C is a flowchart of an exemplary process of on-the-fly estimation of intent/topic of an input query utilizing the semantic cache 210, in accordance with an embodiment of the present teaching. In operation, when the AI-based intent estimator 150 is invoked by the query-based application 140, the intent/topic estimator 240 receives, at 245, a query and determines, at 255, the embeddings of the query, which is then used for identifying, at 265, candidate [Q, I, T] triplets from the semantic cache 210. From the identified candidate [Q, I, T] triplets, a matching [Q, I, T] is selected, at 275, as estimated intent/topic for the received query.

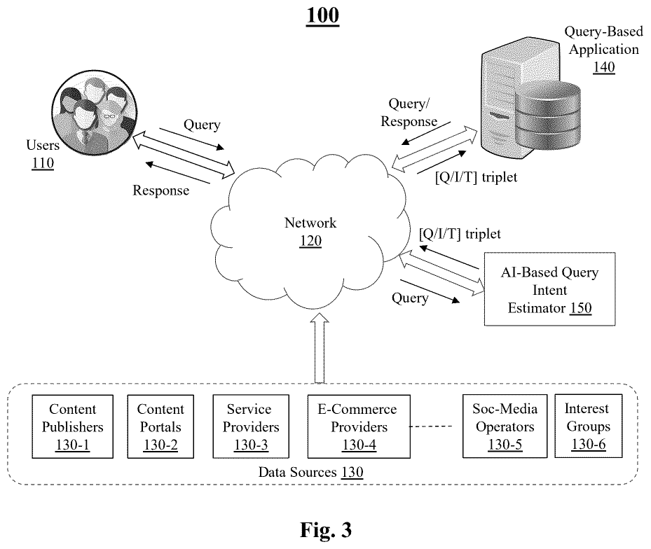

In the illustrated embodiment as shown in FIG. 2A, the AI-based query intent estimator 150 serves as a backend of the query-based application 140. Alternatively, the AI-based query intent estimator 150 may also be operating as a standalone service, offering estimation of query intent/topic on-the-fly to different query-based applications. FIG. 3 depicts this alternative networked setting in which a query-based application operates to seek estimated intent/topic of a query from the AI-based query intent estimator 150 as a service across the network 120, in accordance with an embodiment of the present teaching. As seen, in this alternative setting, when the query-based application 140 receives a query from a user 110, it forwards the query, via the network 120, to the AI-based query intent estimator 150 to seek the service of obtaining intent/topic associated with the query. When the AI-based query intent estimator 150 obtains a matching [Q, I, T] via its on-the-fly operation, and sends the matching triplet, via the network 120, to the inquiring query-based application 140. Based on the received [Q, I, T], the query-based application 140 generates accordingly a response directed to the query and sends it to the user 110 through the network 120.

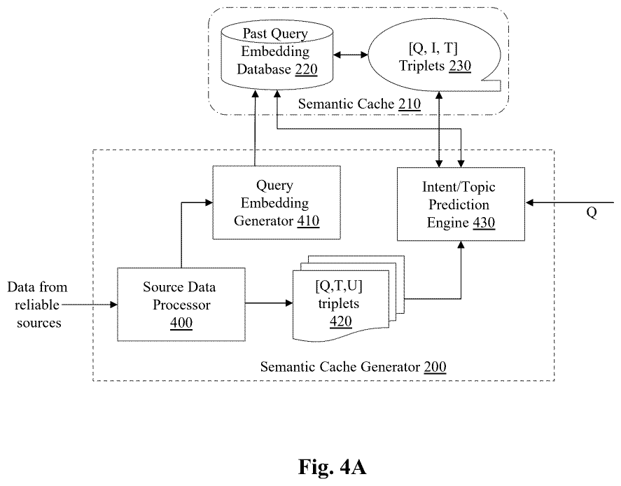

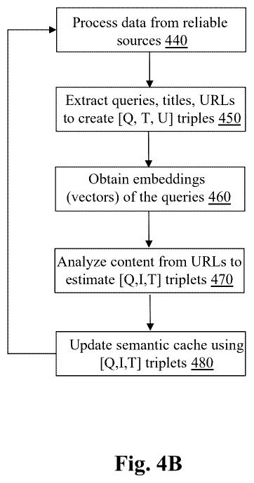

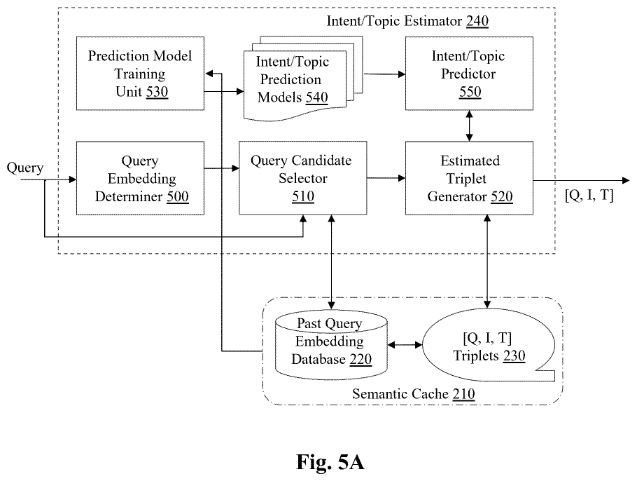

FIG. 4A depicts an exemplary high level system diagram of the semantic cache generator 200, in accordance with an embodiment of the present teaching. In this illustrated embodiment, the semantic cache generator 200 comprises a source data processor 400, a query embedding generator 410, and an intent/topic prediction engine 430. As discussed herein, the semantic cache generator 200 is provided for creating and updating the semantic cache 210 via machine learning based on training data created from data collected from different sources. The source data processor 400 is provided for processing data from different sources and generating training data represented as triplets 420, each of which is represented as [Q, T, U] corresponding to, respectively, a query Q, a title T, and a uniform resource locator (URL) or U pointing to an online document with the title. Such [Q, T, U] triplets 420 may be used as training data by the intent/topic prediction engine 430 to learn the relationship between queries and intents/topics and predict [Q, I, T] triplets, where I represents intent and T represent topics. An example [Q, T, U] may be [Q=“Are ACH transfers a good way to get paid?”, T=“How to accept ACH payments: A simple guide-Forbes Advisor”, U=https://www.forbes.com/advisor/business/accept-ach-payments/]. Its converted [Q, I, T] may be [Q=“Are ACH transfers a good way to get paid?”, I=“General knowledge”, T=“Finance”].

The intent/topic prediction engine 430 may operate to establish/update the [Q, I, T] triplets in semantic cache 210. In its operation, based on training data [Q, T, U] triplets 420, the intent/topic prediction engine 430 may retrieve online documents via URLs included in the triplets and analyze the content of such online documents to estimate corresponding intents/topics, which may then be used to create [Q, I, T] triplets 230 in semantic cache 210. That is, through content analysis, the intent/topic prediction engine 430 converts [Q, T, U] s to [Q, I, T] s and generates [Q, I, T] triplets to establish the semantic cache 210, as shown in FIG. 4A. Such [Q, I, T] triplets 230 in semantic cache 210 created based on data from data sources 130 enables efficient estimation of intent/topic associated with a query on-the-fly. They may also be used as training data by the intent/topic estimator 250 to train a prediction model with a deep understanding of the relations between a long-tail queries and corresponding intents on what to look for as well as the topics of what to look for. With such a prediction model, even when the semantic cache 210 does not include a triplet for a given query, the prediction model may be activated to estimate the intent/topic of a query based on knowledge learned from the training data 230.

To facilitate efficient use of the semantic cache 210, the query embedding generator 410 in FIG. 4A is provided for obtaining embeddings or a vector representation of each long-tail query Q included in [Q, I, T] triplets of the semantic cache 210 and storing such embeddings in the past query embedding database 220 to serve as, e.g., indices to the triplets [Q, I, T] triplets in 230. With such indexing mechanism via embeddings of queries, when a new query is received by the intent/topic estimator 250 from the query-base application 140, the embeddings of the new query may be computed and used to search, via the past query embedding database 220, whether a similar or matching query exists in the [Q, I, T] triplets database 230.

FIG. 4B is a flowchart of an exemplary process of the semantic cache generator 200, in accordance with an embodiment of the present teaching. When data from different data sources 130 is received at 440, the source data processor 400 may extract, at 450, relevant information therefrom such as queries Qs, titles Ts, and URLs to create [Q, T, U] triplets 420. The query embedding generator 410 may obtain, at 460, embeddings for long-tail query Q in each of the triplets 420 to create the past query embedding database 220 in the semantic cache 210. To generate the [Q, I, T] triplets 230, the intent/topic prediction engine 430 analyzes, at 470, content of online documents associated with URLs to estimate intent I and topic(s) T for each of the query Q in each of the [Q, T, U] triplets 420 to create [Q, I, T] triplets, which are then used to update, at 480, the semantic cache 210. As discussed herein, the process of updating the semantic cache 210 may be continuous based on ongoing collection of data from different source to make the content in the semantic cache 210 dynamic and adaptive.

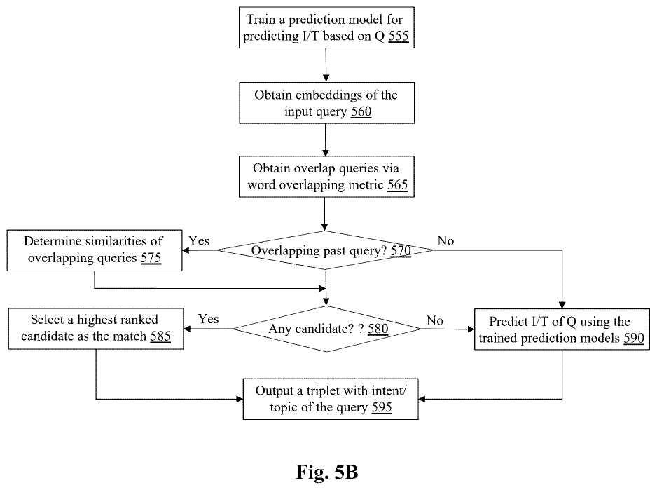

FIG. 5A depicts an exemplary high level system diagram of the intent/topic estimator 250, in accordance with an embodiment of the present teaching. As discussed herein, the intent/topic estimator 250 is provided to estimate, based on the semantic cache 210, intent/topic of a given input long-tail query received from the query-based application 140. The intent/topic estimator 250 operates on-the-fly to provide estimated intent/topic of the input query in two different modes. In the first mode of operation, the query in an existing [Q, I, T] triplet in the semantic cache 210 may be found to match with the input long-tail query. In this case, the previously estimated intent I and topic T in the matching triplet may be used as estimated intent/topic of the input long-tail query. When no matching triplet is found in the semantic cache 210, the intent/topic estimator 250 may operate in a second mode of operation, in which intent/topic prediction models obtained via machine learning using training data [Q, I, T] triplets from the semantic cache 210 may be used to predict, on-the-fly, the intent/topic based on the input long-tail query. To enable the second mode of operation, the intent/topic estimator 250 may also be provided to carry out machine learning of intent/topic prediction models using the [Q, I, T] triplets 230.

In the illustrated embodiment as shown in FIG. 5A, the intent/topic estimator 250 takes a query as input and produces estimated intent/topic for the input query as the output (e.g., in the form of a triplet [Q, I, T]). It comprises a query embedding determiner 500, a query candidate selector 510, an output triplet generator 520, a prediction model training unit 530, and an intent/topic predictor 550. The query embedding determiner 500 is provided to obtain embeddings for an input long-tail query so that the embeddings may be used by the query candidate selector 510 to determine whether some past queries stored in the semantic cache 210 may be considered as similar queries. In some embodiments, candidate past queries may be determined in two phases. In the first phase, candidate past queries may be identified based on, e.g., whether the words in each past query have any overlap with the words in the input query. For example, if an input query is “What is fully vested bonus?”, the following past queries may be selected as overlapping past queries:
“What is total vested bonus?”
“What is vested bonus?”
“What is fully vested benefit?”
“What is fully vested?”
   Such selected overlapping past queries may be further evaluated in the second phase to determine whether they qualify as candidate past queries that match with the input query.

In the second phase, for any past query that overlaps with the input query in words, the semantic similarity between such an overlapping past query and the input query may be further determined. In some embodiments, the similarity between a candidate past query and the input query may be computed based on their respective embeddings, denoted by, e.g., A and B, as illustrated below:

$$similarity ( A , B ) = \frac{{\sum }_{i = 1}^{n} {A}_{i} {B}_{i}}{\sqrt{{\sum }_{i = 1}^{n} {A}_{i}^{2} \sqrt{{\sum }_{i = 1}^{n} {B}_{i}^{2}}}}$$

$$where A ∈ {ℝ}^{n} , B ∈ {ℝ}^{n}$$

where n is the dimension of the embeddings. Any other similarity metric indicative of the affinity between two embeddings may be used. In some implementations, a determination as to whether an overlapping past query qualifies as a candidate matching past query may be made based on some predeterminer condition, e.g., the similarity between the two is to be above a certain level S. If the predetermined condition is satisfied, i.e., the similarity is above a threshold S, then the overlapping past query may be selected by the query candidate selector 510 as a candidate matching past query.

The output triplet generator 520 is provided to generate an output triplet representing the input query Q and its estimated intent and topic(s). As discussed herein, there may be two ways to estimate the intent and topic associated with the input query Q. If the query candidate selector 510 identifies some candidate matching past queries, the output triplet generator 520 operates in the first mode of operation by selecting one of the candidate matching past queries with a triplet [Q′, I′, T′], when Q′ may be the most similar to input query Q and then generating the output as triplet [Q, I′, T′]. If the query candidate selector 510 does not find matching past queries (e.g., either no past query has sufficient word overlap or no similarity exceed the predetermined threshold), the output triplet generator 520 may proceed to the second mode of operation by invoking the intent/topic predictor 550 to predict, based on the input query Q using the previously trained intent/topic prediction models 540, the intent I″ and topic T″ for the input query Q. In this case, the output triplet is generated as [Q, I″, T″]. To enable the operation in the second mode, the prediction model training unit 530 is provided to use the [Q, I, T] triplets 230 in the semantic cache 210 as training data and perform machine learning to train the intent/topic prediction models 540.

FIG. 5B is a flowchart of an exemplary process of the intent/topic estimator 250, in accordance with an embodiment of the present teaching. Based on the [Q, I, T] triplets in the semantic cache 210, the prediction model training unit 530 conduct machine learning to train, at 555, the intent/topic prediction models 540. In operation, when an input query Q is received, the query embedding determiner 500 obtains, at 560, the embeddings of the input query. To identify matching past queries, the query candidate selector 510 may first select, at 565, past queries that have a sufficient level of word overlap with the input query Q. If there is no past query having a sufficient level of word overlap, determined at 570, there will be no matching past query available. In this case, the intent/topic predictor 550 is invoked to predict, at 590, the intent and topic of the input query Q based on the trained intent/topic prediction models 540. The predicted intent and topic may then be used by the output triplet generator 520 to generate an output triplet at 595.

If overlapping past queries are identified, determined at 570, the respective similarities between each of the overlapping past queries and the input query are computed at 575. Based on such computed similarities, it is determined, at 580, whether any of the similarities exceeds the predetermined threshold S, i.e., the corresponding past queries qualify as candidate matching queries. If none of the similarities exceeds S, the intent/topic predictor 550 is invoked to predict, at 590, the intent and topic of the input query Q based on the trained intent/topic prediction models 540. The predicted intent and topic may then be used by the output triplet generator 520 to generate an output triplet at 595. Otherwise, one of the candidate past queries with the highest similarity metric is selected at 585 as the matching past query. In this case, the intent and the topic in the triplet corresponding to the matching past query as stored in the semantic cache 210 are used as the estimated intent and topic of the input query Q and output at 595 as such.

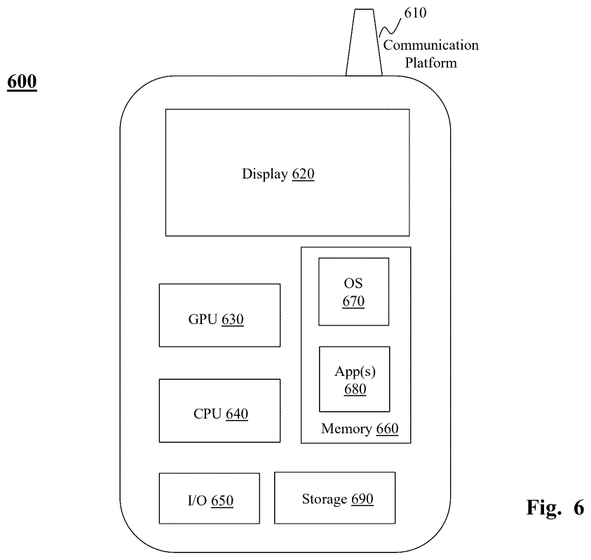

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 500. As shown in FIG. 6, a mobile operating system 670 (e.g., iOS, Android, Windows Phone, etc.), and one or more applications 680 may be loaded into memory 660 from storage 690 in order to be executed by the CPU 640. The applications 680 may include a user interface or any other suitable mobile apps for information analytics and management according to the present teaching on, at least partially, the mobile device 600. User interactions, if any, may be achieved via the I/O devices 650 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

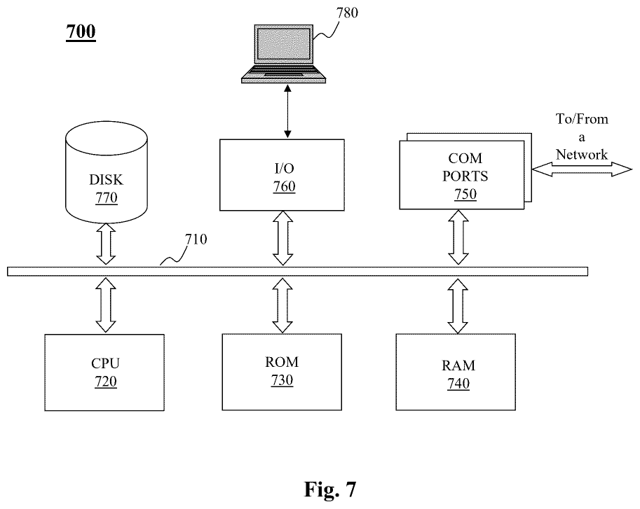

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information analytical and management method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, comprising:
receiving a query from a query-based application that is to perform a query-based tasks in response to the query;
estimating an intent and a topic associated with the query based on a semantic cache having a plurality of triplets, each of which includes a past query, an intent related to the past query, and a topic associated with the past query;
providing the estimated intent and the estimated topic to the query-based application to facilitate execution of the query-based task in accordance with both the query and the estimated intent and the topic of the query associated therewith.

2. The method of claim 1, wherein the query is a long-tail query.

3. The method of claim 1, further comprising creating the semantic cache based on data from one or more data sources.

4. The method of claim 3, wherein the creating the semantic cache comprises:
identifying relevant information from the data, including past queries, links to online documents selected from search results obtained based on the past queries, and titles of the online documents; and
generating the plurality of triplets based on the relevant information by, with respect to each of the past queries,
retrieving the online document based on the link associated with the past query,
estimating intent and topic of the past query by analyzing, with respect to the past query, content of the online document, and
generating a triplet including the past query, the intent, and the topic estimated based on the online document with respect to the past query.

5. The method of claim 1, wherein the estimating the intent and the topic of the query comprises:
determining at least one of the plurality of triplets in the semantic cache, each having its past query similar to the query;
if the at least one triplet exists,
selecting, from the at least one triplet, a matching triplet having its past query best match with the query,
providing the intent and the topic included the matching triplet as the estimated intent and the estimated topic of the query; and
if the at least one triplet does not exist, predicting, using previously trained intent/topic prediction models, the estimated intent and the estimated topic based on the query.

6. The method of claim 5, wherein the step of determining comprises:
calculating a word overlap between the query and a past query of each of the plurality of triplets;
selecting candidate triplets based on the calculated word overlap, wherein the word overlap between the past query in each of the selected candidate triplets and the query satisfies a first criterion;
computing, for each of the candidate triplets, a similarity metric between the past query therein and the query; and
selecting the at least one triplet, wherein the similarity metric of each of the at least one triplet satisfies a second criterion.

7. The method of claim 5, further comprising:
retrieving the plurality of triplets in the semantic cache to generate training data;
conducting machine learning based on the training data; and
generating the intent/topic prediction models for predicting, based on a given query, an intent, and a topic of the given query.

8. A machine-readable and non-transitory medium having information recorded thereon, wherein the information, when read by the machine, causes the machine to perform the following steps:
receiving a query from a query-based application that is to perform a query-based tasks in response to the query;
estimating an intent and a topic associated with the query based on a semantic cache having a plurality of triplets, each of which includes a past query, an intent related to the past query, and a topic associated with the past query;
providing the estimated intent and the estimated topic to the query-based application to facilitate execution of the query-based task in accordance with both the query and the estimated intent and the topic of the query associated therewith.

9. The medium of claim 8, wherein the query is a long-tail query.

10. The medium of claim 8, wherein the information, when read by the machine, further causes the machine to perform the step of creating the semantic cache based on data from one or more data sources.

11. The medium of claim 10, wherein the creating the semantic cache comprises:
identifying relevant information from the data, including past queries, links to online documents selected from search results obtained based on the past queries, and titles of the online documents; and
generating the plurality of triplets based on the relevant information by, with respect to each of the past queries,
retrieving the online document based on the link associated with the past query,
estimating intent and topic of the past query by analyzing, with respect to the past query, content of the online document, and
generating a triplet including the past query, the intent, and the topic estimated based on the online document with respect to the past query.

13. The medium of claim 8, wherein the estimating the intent and the topic of the query comprises:
determining at least one of the plurality of triplets in the semantic cache, each having its past query similar to the query;
if the at least one triplet exists,
selecting, from the at least one triplet, a matching triplet having its past query best match with the query,
providing the intent and the topic included the matching triplet as the estimated intent and the estimated topic of the query; and
if the at least one triplet does not exist, predicting, using previously trained intent/topic prediction models, the estimated intent and the estimated topic based on the query.

13. The medium of claim 12, wherein the step of determining comprises:
calculating a word overlap between the query and a past query of each of the plurality of triplets;
selecting candidate triplets based on the calculated word overlap, wherein the word overlap between the past query in each of the selected candidate triplets and the query satisfies a first criterion;
computing, for each of the candidate triplets, a similarity metric between the past query therein and the query; and
selecting the at least one triplet, wherein the similarity metric of each of the at least one triplet satisfies a second criterion.

14. The medium of claim 12, wherein the information, when read by the machine, further causes the machine to perform the following steps:
retrieving the plurality of triplets in the semantic cache to generate training data;
conducting machine learning based on the training data; and
generating the intent/topic prediction models for predicting, based on a given query, an intent and a topic of the given query.

15. A system, comprising:
a semantic cache generator implemented by a processor and configured for creating a semantic cache with a plurality of triplets, each of which includes a past query, an intent related to the past query, and a topic associated with the query;
an intent/topic estimator implemented by a processor and configured for
receiving a query from a query-based application that is to perform a query-based tasks in response to the query,
estimating an intent and a topic associated with the query based on the semantic cache, and
providing the estimated intent and the estimated topic to the query-based application to facilitate execution of the query-based task in accordance with both the query and the estimated intent and the topic of the query associated therewith.

16. The system of claim 15, wherein the query is a long-tail query.

17. The system of claim 15, wherein the creating the semantic cache comprises:
identifying relevant information from the data, including past queries, links to online documents selected from search results obtained based on the past queries, and titles of the online documents; and
generating the plurality of triplets based on the relevant information by, with respect to each of the past queries,
retrieving the online document based on the link associated with the past query,
estimating intent and topic of the past query by analyzing, with respect to the past query, content of the online document, and
generating a triplet including the past query, the intent, and the topic estimated based on the online document with respect to the past query.

18. The system of claim 15, wherein the estimating the intent and the topic of the query comprises:
determining at least one of the plurality of triplets in the semantic cache, each having its past query similar to the query;
if the at least one triplet exists,
selecting, from the at least one triplet, a matching triplet having its past query best match with the query,
providing the intent and the topic included the matching triplet as the estimated intent and the estimated topic of the query; and
if the at least one triplet does not exist, predicting, using previously trained intent/topic prediction models, the estimated intent and the estimated topic based on the query.

19. The system of claim 18, wherein the step of determining comprises:
calculating a word overlap between the query and a past query of each of the plurality of triplets;
selecting candidate triplets based on the calculated word overlap, wherein the word overlap between the past query in each of the selected candidate triplets and the query satisfies a first criterion;
computing, for each of the candidate triplets, a similarity metric between the past query therein and the query; and
selecting the at least one triplet, wherein the similarity metric of each of the at least one triplet satisfies a second criterion.

20. The system of claim 18, further comprising a prediction model training unit implemented by a processor and configured for:
retrieving the plurality of triplets in the semantic cache to generate training data;
conducting machine learning based on the training data; and
generating the intent/topic prediction models for predicting, based on a given query, an intent and a topic of the given query.
